(19) United States
(12) Patent Application Publication
(10) Pub. No.: US 2018/0253701 A1
(43) Pub. Date: Sep. 6, 2018

(54) SYSTEM AND METHOD FOR TRACKING AND MAINTAINING EQUIPMENT

(71) Applicant: Kapios, LLC, Toledo, OH (US)

(72) Inventors: Amanda Wright, Toledo, OH (US); Joan Fuller, Toledo, OH (US); Kimberly Thomas, Toledo, OH (US); Sandy Maugel, Toledo, OH (US); Linda Spencer, Toledo, OH (US); Mark Sattler, Toledo, OH (US); Veronica Rashleigh, Toledo, OH (US)

(21) Appl. No.: 15/913,272

(22) Filed: Mar. 6, 2018

Related U.S. Application Data
(60) Provisional application No. 62/467,275, filed on Mar. 6, 2017.

(51) Int. Cl. G06Q 10/00; G06Q 10/08; G06Q 10/06

(52) U.S. Cl. CPC G06Q 10/20; G06Q 10/06; G06Q 10/087

(57) ABSTRACT

A method and system for tracking and maintaining equipment, such as in a medical equipment processing laboratory. A database server is provided with an administrative portal application allowing an administrator to add users, define stations within a laboratory, define instruments at each station, and create maintenance log forms for each instrument. Laboratory technicians use a mobile tablet application to complete the maintenance log forms according to established schedules, such as daily or weekly. Completed maintenance log forms are uploaded to the server and compared to the established schedules. Alerts are sent to supervisors for any items not completed according to schedule. The supervisors can also review compliance percentages, manage the workload of individual technicians, and produce reports and documentation for usage in periodic compliance audits and inspections.

### CROSS-REFERENCE TO RELATED APPLICATIONS

This application claims the benefit of the priority date of U.S. Provisional Patent Application Ser. No. 62/467,275, titled SYSTEM AND METHOD FOR TRACKING AND MAINTAINING EQUIPMENT, filed Mar. 6, 2017.

### BACKGROUND

### Field

The present disclosure relates generally to the field of equipment maintenance tracking and, more particularly, to a system and method for tracking and maintaining equipment including defining instruments needing regularly-scheduled cleaning or maintenance, creating electronic forms for each cleaning or maintenance activity, tracking the completion of each activity according to a schedule, and notifying a supervisor of any uncompleted activities.

### Discussion

For equipment, such as medical laboratory equipment, for example, maintenance and regular cleaning is required to extend a useful life and appropriate conditions of use for the equipment. Typically, maintenance and tracking schedules are managed by charts or other paper listings. With such manual tracking, untimely maintenance or cleaning occurs, equipment goes untracked or accounted for, and supervisors of the laboratory may not be aware that maintenance or cleaning is not occurring in a timely fashion.

In the case of medical laboratory equipment, not only is paper-based maintenance tracking inefficient and labor-intensive, but it also cannot ensure compliance with regulatory inspection and auditing requirements. When an audit is conducted of a medical laboratory's equipment inspection and maintenance paper-based logs, non-compliances are often uncovered, which can lead to reduced quality ratings or decertification for the laboratory. With paper-based records, the only way to prevent audit non-compliances is to add more wasteful manual records-checking labor.

In order to improve the efficiency of laboratory technicians and supervisors and avoid the pitfalls of audit non-compliance, a software solution is needed which automates the documentation of laboratory equipment maintenance, cleaning and inspection.

### SUMMARY

In accordance with the teachings of the present disclosure, a method and system are provided for tracking and maintaining equipment, such as in a medical equipment processing laboratory. A database server is provided with an administrative portal application allowing an administrator to add users, define stations within a laboratory, define instruments at each station, and create maintenance log forms for each instrument. Laboratory technicians use a mobile tablet application to complete the maintenance log forms according to established schedules, such as daily or weekly. Completed maintenance log forms are uploaded to the server and compared to the established schedules. Alerts are sent to supervisors for any items not completed according to schedule. The supervisors can also review compliance percentages, manage the workload of individual technicians, and produce reports and documentation for usage in periodic compliance audits and inspections.

Additional features of the presently disclosed methods and systems will become apparent from the following description and appended claims, taken in conjunction with the accompanying drawings.

### BRIEF DESCRIPTION OF THE DRAWINGS

FIG. 1 is an architecture diagram of a Laboratory Assured Compliance Solution (LACS) system, according to an embodiment of the invention;

FIG. 2 is an illustration of an application page for defining instruments in LACS, in accordance with an embodiment of the disclosed system;

FIG. 3 is an illustration of an application page for defining frequencies for form completion in LACS, in accordance with an embodiment of the disclosed system;

FIG. 4 is an illustration of an application page for creating a form in LACS, in accordance with an embodiment of the disclosed system;

FIG. 5 is an illustration of application pages used for creating a new slide in a form in LACS, in accordance with an embodiment of the disclosed system;

FIG. 6 is an illustration of a sequence of mobile tablet application pages for a technician user logging into LACS, in accordance with an embodiment of the disclosed system;

FIG. 7 is an illustration of a sequence of mobile tablet application pages for a technician user selecting an instrument and report in LACS, in accordance with an embodiment of the disclosed system;

FIG. 8 is an illustration of the screen which displays the instruments for the particular station as a grid of images and names, in accordance with an embodiment of the disclosed system;

FIG. 9 is an illustration of the screen which displays the reports available for a particular instrument, in accordance with an embodiment of the disclosed system;

FIG. 10 is an illustration of a screen which displays a report to be completed for a particular instrument, in accordance with an embodiment of the disclosed system;

FIG. 11 is an illustration of a sequence of mobile tablet application pages for a technician user completing slide bar questions in LACS, in accordance with an embodiment of the disclosed system;

FIG. 12 is an illustration of a sequence of mobile tablet application pages for a technician user completing a signature question in LACS, in accordance with an embodiment of the disclosed system;

FIG. 13 is an illustration of a sequence of mobile tablet application pages for navigating using the side navigation menu, in accordance with an embodiment of the disclosed system;

FIG. 14 is an illustration of a dashboard screen which displays statistics from LACS, in accordance with an embodiment of the disclosed system;

FIG. 15 is an illustration of a calendar screen which displays LACS statistics in a calendar format, in accordance with an embodiment of the disclosed system;

FIG. 16 is an illustration of an Alert Messages screen which displays a table of recent alert messages in LACS, in accordance with an embodiment of the disclosed system;

FIG. 17 is an illustration of a left sidebar menu which contains report reviewing commands in LACS, in accordance with an embodiment of the disclosed system; and

FIG. 18 is a flowchart diagram of a method for tracking equipment maintenance tasks employing the features of the LACS system shown in FIGS. 1-17.

### DETAILED DESCRIPTION OF THE EMBODIMENTS

The following discussion of the embodiments of the disclosure directed to a method and system for tracking and maintaining equipment is merely exemplary in nature, and is in no way intended to limit the disclosed techniques or their applications or uses. For example, the invention is described in the context of medical laboratory equipment, but is anticipated to be useful with equipment of many types. In respect of the methods disclosed, the steps presented are exemplary in nature, and thus, steps may be added, removed or reordered without departing from the spirit and scope of the invention.

Laboratory instrument maintenance documentation and regulatory compliance challenges are ubiquitous among medical laboratories throughout the country. Instruments must be cleaned, checked and calibrated at regular intervals, and logs must be meticulously updated to meet regulatory requirements. With paper and pen documentation, it is easy for tasks to fall through the cracks or be recorded incorrectly. Healthcare organizations need a better way to track and manage tasks and maintenance logs.

At any accredited medical laboratory, many “checks” of the laboratory equipment (cleaning, inspection, etc.) must be performed and documented at specified intervals—i.e., once every 24 hour period. If one or more checks are not performed, there is no alert if the documentation process is manual. There are many reasons that a check can be missed, such as; the assigned staff member is busy with patient testing and forgets the check, the technician is absent and the task is not reassigned, the testing equipment or cleaning supplies are unavailable, etc.

The laboratory's accrediting body, at inspection time, reviews all equipment maintenance documentation. If any checks are not completed in their defined time window, the organization may be cited for gaps in quality control. As the volume and complexity of testing (and required quality controls) increases, compliance becomes more time-consuming and the risk of one or more events of non-compliance becomes more likely. Under a manual system, additional “checks” on the quality checks may be imposed, layer upon layer. However, this is still a human-based system and therefore, error (overlooking a quality control check) is still possible.

The problems associated with manual, paper-based laboratory equipment maintenance logs, described above, were the genesis for an improved method utilizing an electronic solution. The Laboratory Assured Compliance Solution is a system which provides a digital repository for these quality checks, accessible from dedicated mobile tablet devices which replace the old paper clipboards, and includes rules-based logic around the required frequency of quality control checks, and alerts as to which quality checks have not yet been completed within the defined window of time.

The Laboratory Assured Compliance Solution provides a secure, centralized database for users to record and review equipment status, access historical records and run reports, all in real-time from a mobile device or a desktop browser anytime, anywhere. It also ensures that regulatory activities are performed in a timely manner. If a scheduled activity is not logged as completed, the system triggers a chain of alerts until the task is addressed. The Laboratory Assured Compliance Solution replaces cumbersome papers and notebooks with one mobile device to boost the productivity of lab engineers and technicians and help maintain the integrity of the documentation. The Laboratory Assured Compliance Solution can be applied to any production equipment operation (laboratory, pharmacy, nursing crash cart checks, etc.) that must comply with periodic checks to be completed by different individuals.

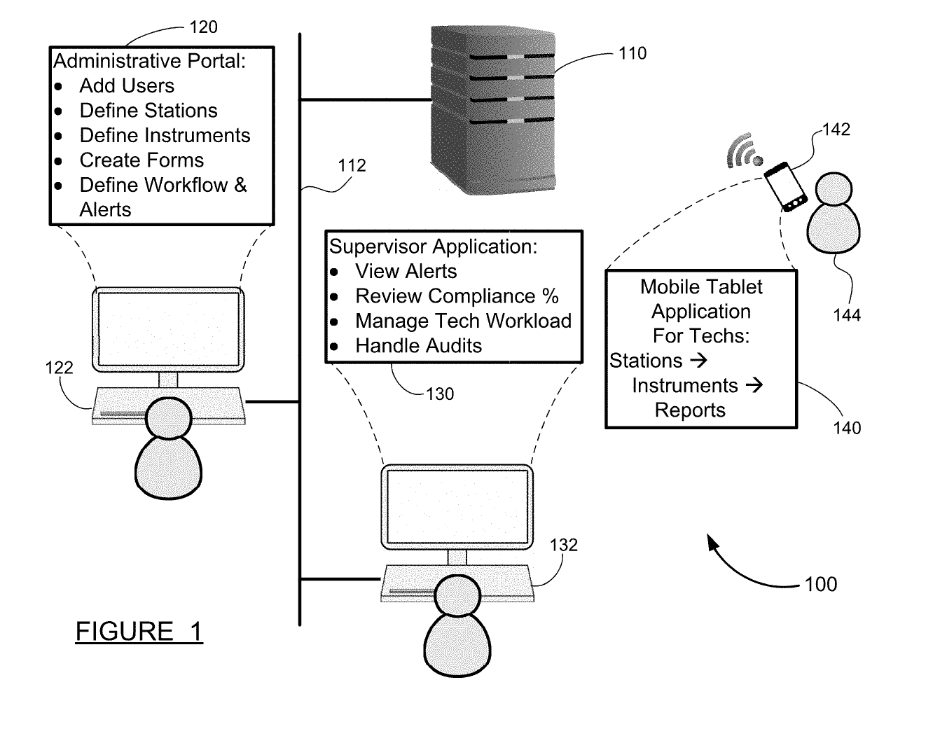

FIG. 1 is an architecture diagram 100 of the Laboratory Assured Compliance Solution (LACS) system, according to an embodiment of the invention. A server computer 110 contains a database of all laboratory stations, instruments, forms and workflow as described in the following discussion. The server 110 also manages users and roles, passwords, etc., as would be understood by anyone familiar with enterprise application software. The server 110 may be physically located on site at a laboratory, or may be a cloud server located remotely.

An administrative portal 120, running on a computer 122 communicating with the server 110 via a network 112, provides all administrative functions for the LACS system. The network 112 may be a local area network (LAN) such as Ethernet running in a building, or may be the Internet. The administrative portal 120 provides administrative functions including adding users and assigning users to roles, and defining the hierarchy of stations, instruments, forms and workflow associated with a laboratory. The administrative portal features and functions will be discussed in detail below.

A supervisor application 130, running on a computer 132 communicating with the server 110 via the network 112, provides all laboratory supervisor functions in the LACS system. The supervisor application 130 allows laboratory supervisors to view alerts generated as a result of forms not completed on time, review compliance percentages by time, by laboratory stations, by technician, etc., manage the workload of individual technicians, and produce documentation needed for compliance audits. The supervisor application features and functions will be discussed in detail below. The computer 132 may be the same as the computer 122, of course, or there may be more than two such computers being used by multiple people.

A mobile tablet application 140, running on a plurality of mobile tablet devices 142 wirelessly communicating with the server 110, provides all electronic forms to be completed by technicians 144 using the LACS system. The mobile tablet devices 142 communicate with the server 110 using any suitable wireless technology—including Wi-Fi and cellular communication, among others. The mobile tablet application 140 allows the technicians 144 to select a station and instrument, view forms which are due or overdue to be completed, complete forms as needed, including saving partially-completed drafts, and submit the completed forms to the server 110. The mobile tablet application features and functions will be discussed in detail below.

The following discussion of the administrative portal 120 will both explain the features and functions of the administrative portal 120, and outline the hierarchy of the database—the forms and the parts of the laboratory with which the forms are associated.

One of the first steps in setting up the LACS system by a system administrator is creating or defining users in the system. Technician-level users only have access to the tablets 142 to fill out and complete report forms. The notifications and alerts for upcoming tasks received by non-administrative users will be dependent on the user's role in the system. There are three different non-administrative roles—supervisor, basic technician and advanced technician. Users having the technician roles may be assigned to different stations and instruments in the laboratory, as discussed later, while supervisors have report approval authority and access to all data and statistics about completed and incomplete report forms.

A particular instance or implementation of the LACS system applies to one laboratory. A laboratory might be, for example, the “medical laboratory at the Columbus Hospital”. In LACS, the single laboratory is subdivided into stations. The first step in defining the actual hierarchy of a laboratory in LACS is creating stations. The different stations will have instruments assigned to them in the application. Then the forms will be assigned to the instruments at those stations. Thus, setting up the stations first will facilitate the rest of the hierarchy definition.

A typical laboratory will include several stations. Stations in a laboratory may include, for example, Blood Bank, Chemistry, Hematology, Outpatient, Processing and Urinalysis. Because all of the stations in the LACS system belong to the same laboratory, creating a station by an administrator is as simple as giving the new station a name or title and a description.

The level of hierarchy below stations is instruments; that is, instruments belong to stations. Before defining instruments, it is useful to create a list of Chemical Types. When an instrument is added (discussed below), the administrator will be able to designate a Type for the instrument. This may be as simple as “Instrument” for any physical item, but chemical instruments will need to be more specific. Creating a comprehensive list of chemical instrument types before creating the instruments themselves will ensure that the Type dropdown is completely populated when the administrator creates the different instruments and assigns the instruments to the stations, which is the next step.

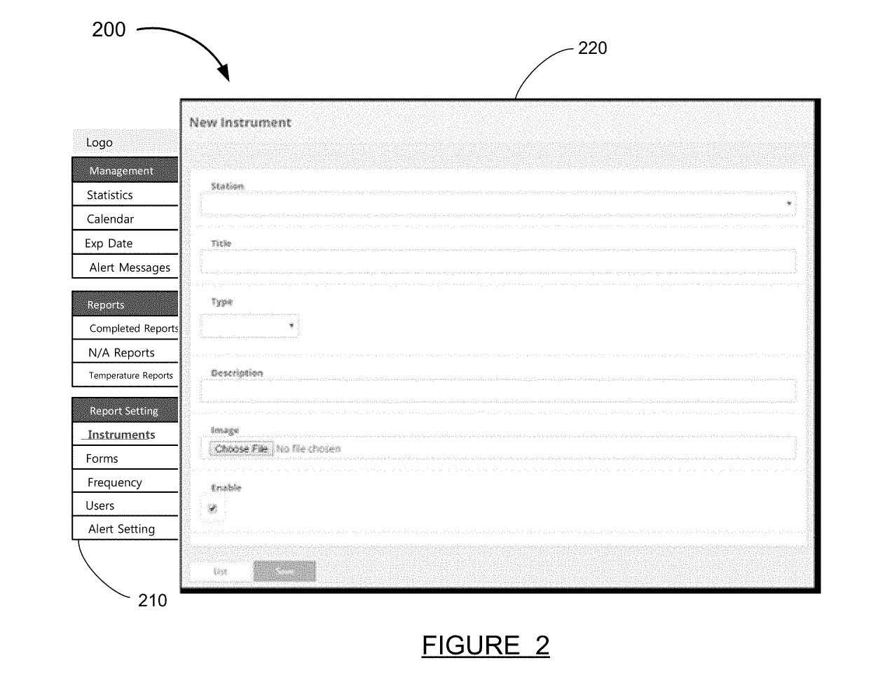

FIG. 2 is an illustration 200 of an application page for defining instruments in LACS, in accordance with an embodiment of the disclosed system. Many screens in the LACS system include a left sidebar 210. The sidebar includes a Management section, a Reports section and a Report Settings section. The Report Settings section includes an option for Instruments, where instruments can be created and viewed.

When creating a new instrument, first a Station is selected, as shown at the top of main window 220, where the instrument will be associated with the selected station for reporting purposes. The stations were defined previously. After selecting a station from the droplist, the instrument is given a title (name) and a description. The title may be the make and model of a laboratory test instrument, for example. Then an instrument Type is defined from a droplist. As mentioned above, the type may simply be “instrument” for a mechanical test instrument, or the type may be a chemical type, also previously defined and available in the droplist.

After entering an instrument description, an image may be provided for the instrument. The image will later be shown in the mobile tablet application 140, so that a technician can visually verify that an instrument they have selected for form completion is the correct device. A QR code (2-D barcode) may also be defined for an instrument, allowing for the instrument to later be selected by the QR code.

After entering all of the information on the instrument form as shown in FIG. 2, the instrument can be saved to the LACS database. Many instruments are typically defined for each station, for each of the stations in the laboratory, in the manner discussed above.

As mentioned previously, the ultimate function of the LACS system is to allow maintenance log forms to be completed electronically, rather than on paper. Before defining the forms associated with each instrument, it is necessary to determine the frequencies at which the various forms will need to be completed, and to establish these frequencies in the LACS database. For scheduled forms, the users will be required to perform those tasks at a particular frequency. For instance, cleaning an instrument may need to be done daily. Setting up the frequencies first will ensure that the administrator can simply choose the frequency from a drop down while creating a form for a scheduled task.

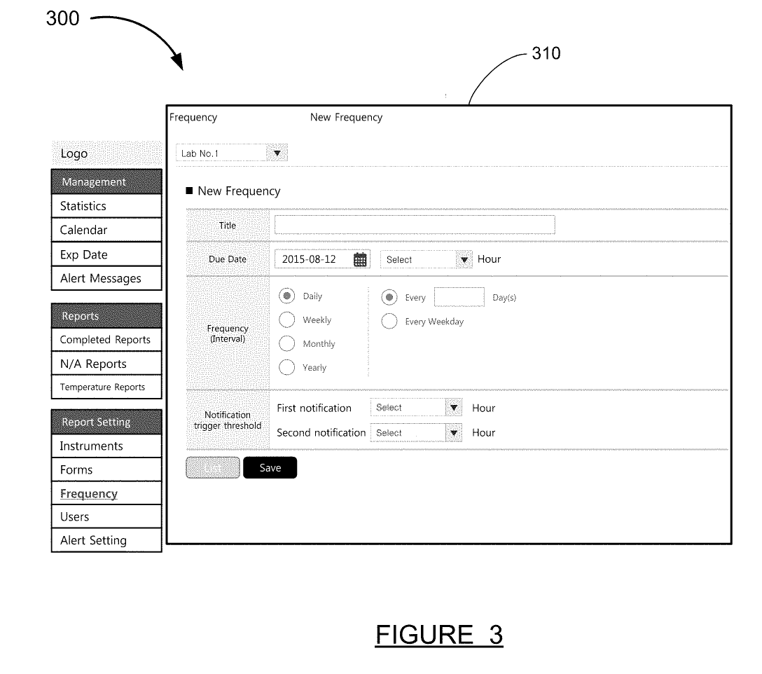

FIG. 3 is an illustration 300 of an application page for defining frequencies for form completion in LACS, in accordance with an embodiment of the disclosed system. Examples of frequencies which may be defined in LACS are: daily at a particular time, such as 1700 hours (5:00 pm); weekly on Tuesdays (or any particular day); monthly at month-end (or beginning, or mid-month, or on a particular day); quarterly; annually; bi-annually; etc. As seen in main window 310, each of the frequencies is given a name or title, a starting date, and criteria for sending alerts when overdue. Alerts are discussed further below.

Now that all of the laboratory hierarchy dependencies (stations, instruments and chemicals, and frequencies) have been defined, the administrator can proceed with creating forms. This should be a smooth process, because the station, instrument, and frequency drop down lists are populated and ready to go. If a new station, instrument or frequency is needed, the administrator can go back to those sections of the administrative portal 120 and add what is needed at any time.

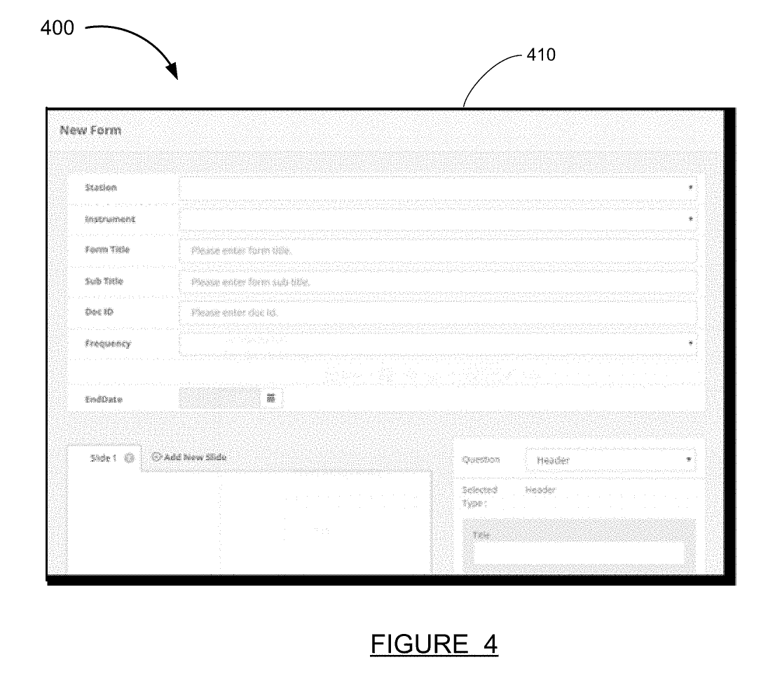

FIG. 4 is an illustration 400 of an application page for creating a form in LACS, in accordance with an embodiment of the disclosed system. As discussed above, each form (i.e., maintenance report form) is associated with an instrument, and each instrument in turn belongs to a station. Thus, it is seen in window 410 that a new form is defined by first selecting a station from a drop list of stations in the laboratory, and then selecting an instrument from a drop list of instruments in the selected station. These selections establish the proper hierarchical relationships in the LACS database. Multiple forms can be created for each instrument, where the different forms may be defined for different frequencies, or different activities, etc. For example, a form for daily cleaning of an instrument would be different than a form for quarterly maintenance or calibration of the same instrument.

The new form is then given a title, a sub title and a unique document ID, all of which are displayed on the tablet device 142 when a technician is filling out the report form in actual usage. A frequency for the form is then selected from a drop list, where the frequency types (daily, weekly, etc.) were discussed above. Forms may also be given an end date. Each form in the LACS system consists of one or more slides. A slide is an individual screen on the tablet device 142, and corresponds to a sheet of paper in the old paper-based forms process. At the bottom of the window 410, a default first slide tab is visible, along with an option to add another slide.

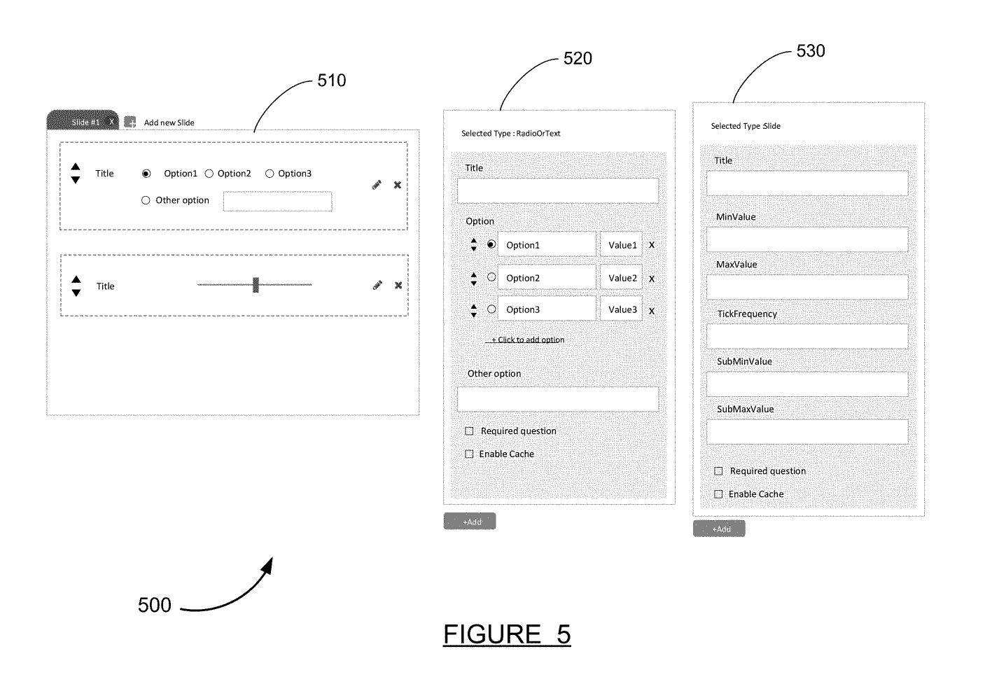

FIG. 5 is an illustration 500 of application pages used for creating a new slide in a form in LACS, in accordance with an embodiment of the disclosed system. A slide window 510 shows a current slide with questions being added. Many different types of question-builder tools are available for creating forms in LACS. FIG. 5 shows two of them—a question with a radio button selection in tool 520, and a question with a slider bar response in tool 530. As understood by those skilled in the art, radio buttons are used to select one item from a list of alternatives. Thus, when a technician clicks on one radio button, that item is selected to the exclusion of the other options. A radio button question can be set up with or without a keyed-in value for the selected option, or an optional selection, as shown on FIG. 5. Slider bars are useful for allowing input of a value from a range which is known in advance—such as the temperature of a chemical solution in a tank of an instrument during inspection. Slider bar questions allow the administrator to define a maximum and minimum value of the range, along with unit increments to be displayed on the slider bar.

Many other types of question-builder tools are available for creating forms in LACS—including Yes/No selections, drop lists, checkboxes (which allow more than one selection, and may be used with or without typed value), various types of text entry fields (date, text, number, auto-complete) and a signature field. Question type (radio button, etc.) is selected from a drop list for each new question to be added to a slide of a form, as seen in FIG. 4. Using the tools shown in FIGS. 4 and 5 and described above, forms can be created by the administrator to capture any equipment maintenance, cleaning or calibration activity performed in the laboratory. Completed report forms are submitted by technicians to the LACS database, where they provide a permanent and easily searchable record of all such activity. Any time a form is not completed and submitted by the designated date/time, an alert is sent to bring attention to this, as discussed further below.

The preceding discussion of the administrative portal 120 describes how the LACS system is set up prior to actual technician usage. The following discussion of the mobile tablet application 140 describes how the technicians 144 use the tablets 142 to complete and submit forms—such as maintenance and cleaning log forms—which were previously filled out on paper prior to the advent of LACS.

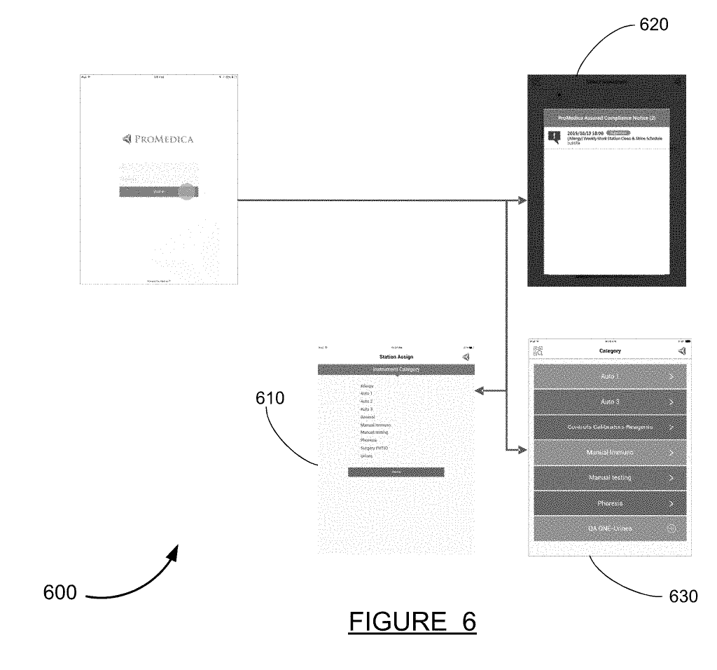

FIG. 6 is an illustration 600 of a sequence of mobile tablet application pages for a technician user logging into LACS, in accordance with an embodiment of the disclosed system. A technician selects one of the mobile tablet devices 142 configured for the laboratory in which he/she works. The technician logs into LACS using their login credentials. At this point, there are three scenarios for what can happen, depending on whether the technician has been pre-assigned to a station in the laboratory.

If the technician has not been assigned to a station, a screen 610 will be displayed, which prompts the technician to select one or more station assignments. A user's stations are selected from the list of stations in the laboratory, as discussed above in relation to FIG. 2. If the technician has been pre-assigned to one or more stations, or after the technician selects station assignments from the screen 610, then one of two remaining scenarios will play out.

If the station(s) to which the technician is assigned have any incomplete reports which are past their due date/time, then a notification screen 620 will pop up to immediately draw the technician's attention to the overdue items. In such a situation, the technician can tap the overdue item to be taken directly to the form which needs to be completed. If the station(s) to which the technician is assigned do not have any overdue reports, then a station selection screen 630 is displayed, where the technician can select one of the stations to which he/she is assigned, and proceed to instruments and reports from there. In the LACS system, a “form” is created by an administrator and includes one or more slides, as discussed above, while a “report” is what the form is called when it is completed by a technician using the mobile tablet application 140.

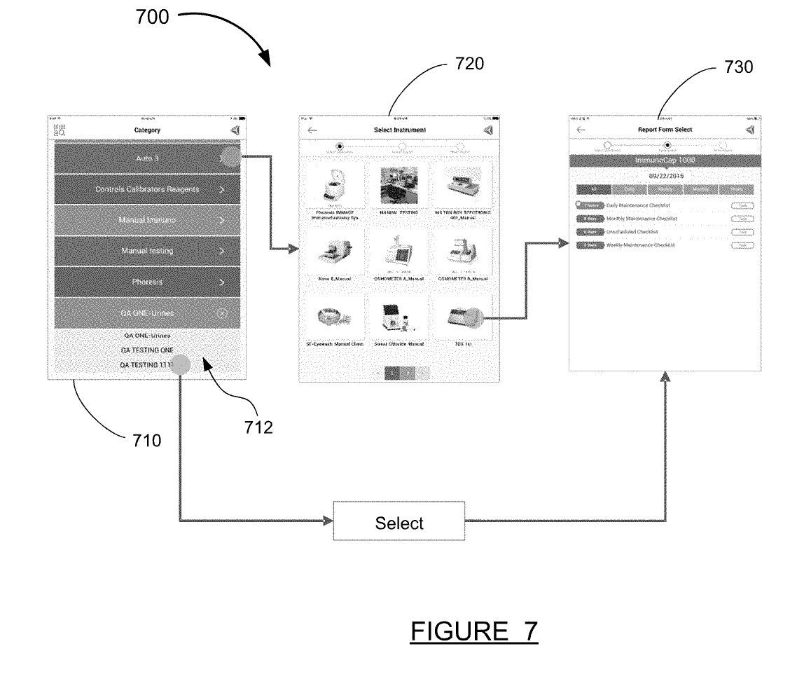

FIG. 7 is an illustration 700 of a sequence of mobile tablet application pages for a technician user selecting an instrument and report in LACS, in accordance with an embodiment of the disclosed system. There is more than one way for a technician user to select an instrument and report. A screen 710 shows a list of stations to which the technician user has been assigned, similar to the screen 630 of FIG. 6. If the user selects (taps on) one of the stations, then a list of instruments in the station is displayed in a screen 720.

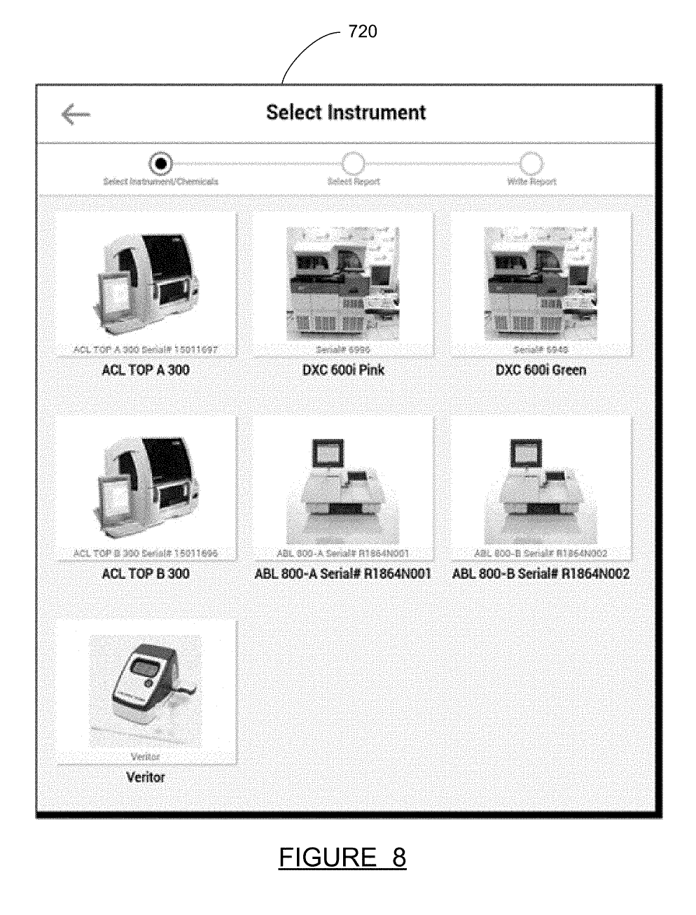

FIG. 8 is an illustration of the screen 720 which displays the instruments for the particular station as a grid of images and names, in accordance with an embodiment of the disclosed system. The images in the screen 720 make it easy for the technician to identify the instrument that they want to work on. When the technician selects an instrument from the screen 720, a list of reports for that instrument in a screen 730 (FIG. 7). Alternately, instruments for a station can be displayed in accordion format in the screen, as shown at 712 in FIG. 7.

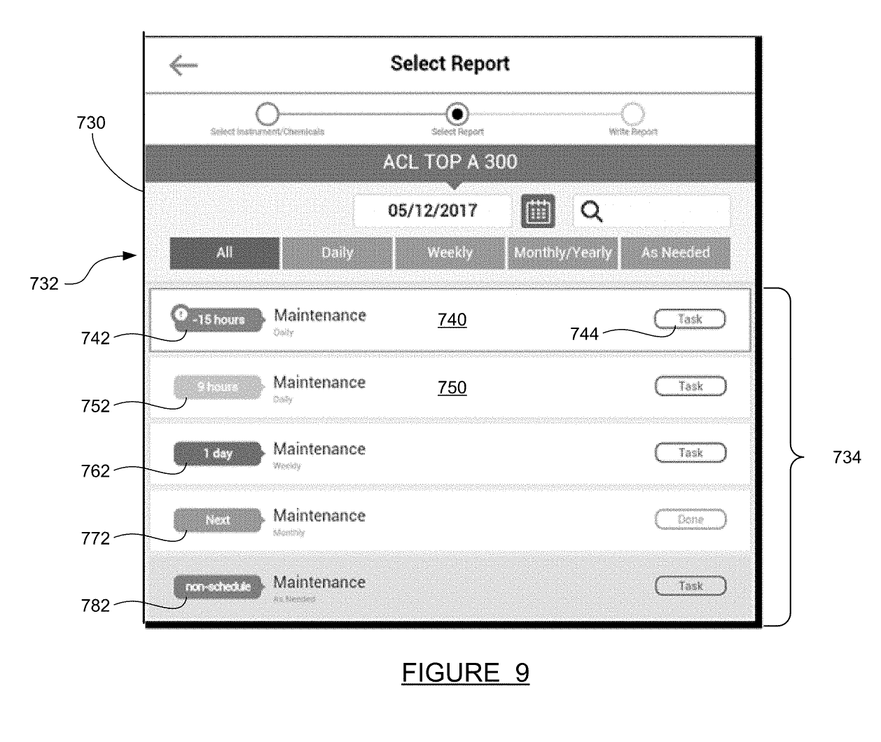

FIG. 9 is an illustration of the screen 730 which displays the reports available for a particular instrument, in accordance with an embodiment of the disclosed system. Several features for viewing reports for a particular instrument are available, as shown in FIG. 9. Buttons 732 can be used to view all reports for an instrument, or only those with frequencies set to daily, weekly, monthly/yearly, or as needed. By using one of the buttons 732, a technician user can quickly filter the list of reports to, for example, just the daily maintenance reports.

Based on the filter applied by the selected button 732, a list 734 of reports is displayed. The list 734 includes, for each report, a basic name such as “Maintenance”, a frequency (Daily, Weekly, etc.), and a color-coded due/overdue tag. For example, a report 740 is a daily maintenance report for the selected instrument “ACL TOP A300”. The report 740 is overdue by 15 hours, as indicated by the negative 15 hours shown in tag 742. The tag 742 is color coded in red, and includes an exclamation point (!) to highlight the fact that this report is overdue.

A report 750 is the same daily maintenance report as the report 740, except the report 750 is the report which is due one day later than the report 740. Thus, where the report 740 is overdue by 15 hours, the report 750 is due in nine hours, as indicated by tag 752. The tag 752 is colored yellow in the LACS system, as it indicates a number of hours in the future that a report is due. A blue tag 762 indicates a number of days in the future that a report is due. Green tags indicate a month in the future. A grey tag 772 will say “Next” if a report is not due until the next cycle, such as the next month. A brown tag 782 applies to reports which are not scheduled, but are simply done as needed. From the list 734 of reports available, the technician user selects a report to complete by tapping the “Task” button, such as Task button 744.

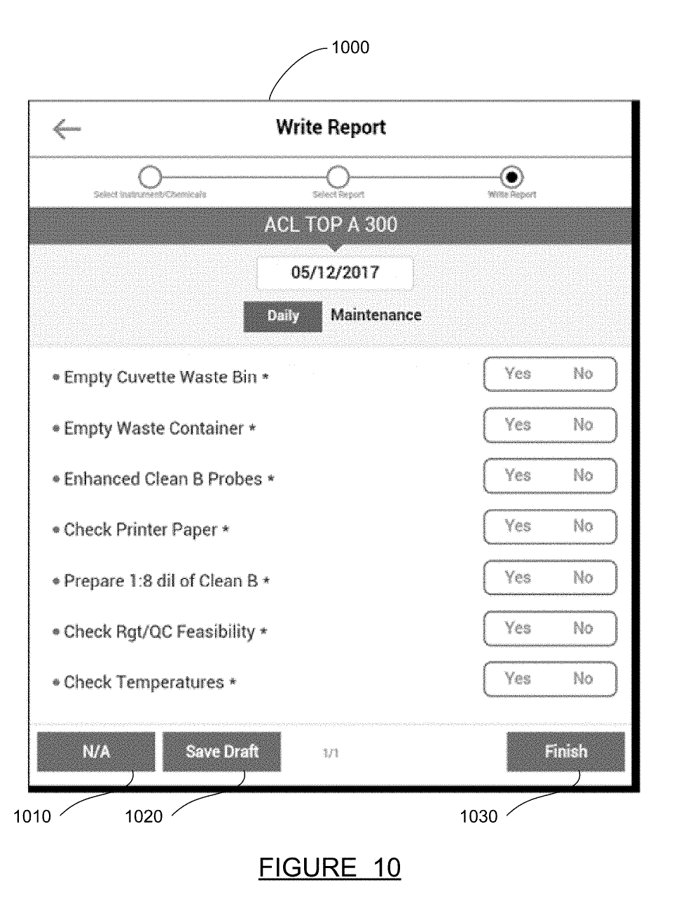

FIG. 10 is an illustration of a screen 1000 which displays a report to be completed for a particular instrument, in accordance with an embodiment of the disclosed system. The report shown in the screen 1000 is the daily maintenance report for the instrument “ACL TOP A 300” of FIG. 9. This particular report simply includes a list of yes/no questions, as observed in the center part of the screen 1000. This report consists of only one slide, as noted by the “1/1” indication at the bottom. If more than one slide were included in the report (each slide containing different questions), then the slide numbers would be displayed at the bottom, and the technician user would “swipe” sideways on the tablet device display to select and complete each slide in the report.

Three buttons are typically available at the bottom of the report screen 1000. An N/A button 1010 is selected by a technician user when a report needs to be recorded as “not applicable” for a certain reporting cycle. For example, if an instrument has a daily maintenance report due each day, but the instrument is broken or otherwise out of service, then the technician user can go to the report screen 1000 for that instrument for that day, and tap the N/A button 1010 without answering any of the questions on the screen 1000. A window will then pop up allowing the user to select a reason the report is not applicable (machine out of service or broken, no testing performed that day, etc.). When the user hits “OK” on the pop-up window, the report is then saved with N/A status in the LACS database. A report that has been saved as N/A will not generate an alert or show as overdue.

A Save Draft button 1020 can be selected by a technician user to save a partially completed report. This feature is useful for lengthy reports which include more time-consuming testing, measurement, cleaning or calibration. When a user taps the Save Draft button 1020, all of the questions which have so far been answered are saved for the report, but the report is not designated as completed. Thus, after doing a Save Draft, the user must still complete and finish the report in order to avoid the report being flagged as overdue.

A Finish button 1030 is tapped by the user to save and finish the report. When the Finish button 1030 is tapped, the tablet application 140 runs a check to ensure that all required questions (designated by an asterisk, as shown on FIG. 10) have been answered. If all required questions are answered, then a pop-up window indicates that the task was successful, the report is saved to the LACS database, and the status of the particular instance of the report is changed to completed. If a user taps the Finish button 1030 but one or more required questions have not been answered, then a pop-up window indicates that the save was not successful, and the user must acknowledge this pop-up window and continue working on the report until all required questions are answered and a successful Finish is accomplished.

It will be recalled from the brown tag 782 of FIG. 9 that non-scheduled reports may appear on a list of reports for an instrument. Non-scheduled reports do not have a due date/time, but rather are completed by technicians on an as-needed basis. If a technician user selects a non-scheduled report, the report will appear in a screen similar to the screen 1000 of FIG. 10. The technician user can complete the questions and tap the Finish button on a non-scheduled report, just like any other report. Unlike other reports, however, non-scheduled reports do not generate overdue alerts, because they have no scheduled due date/time.

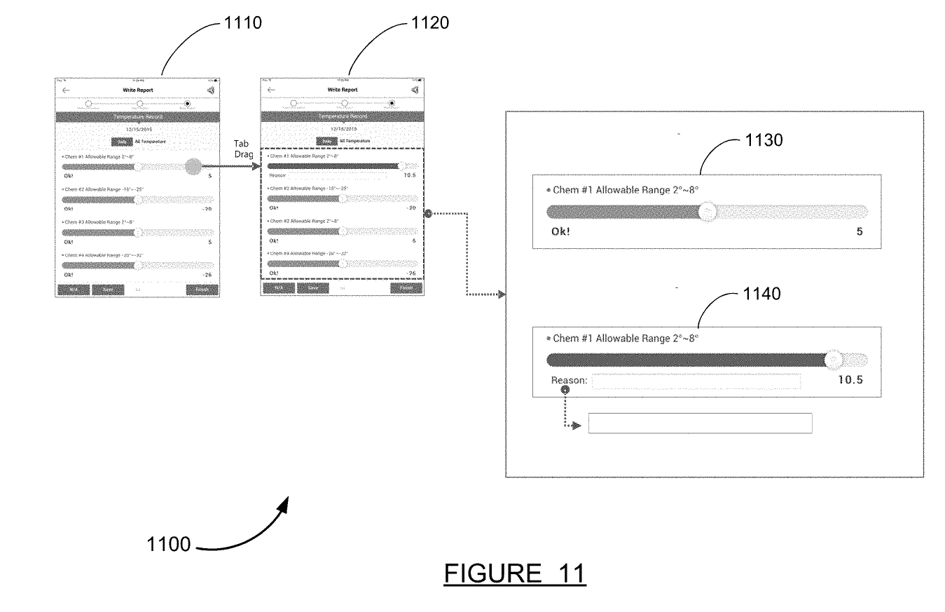

Aside from the simple types of questions—such as yes/no, radio buttons and drop lists—there are some types of questions which require additional explanation. One of these is the slide bar question. FIG. 11 is an illustration 1100 of a sequence of mobile tablet application pages for a technician user completing slide bar questions in LACS, in accordance with an embodiment of the disclosed system. When an administrator creates a slide bar question on a form, the slide bar (recording a temperature of a chemical, for example) can have an allowable range established by the administrator. When the technician user is completing the report, the user taps and drags the slider to change the value from the default, as shown in screen 1110. If the user drags the slider to a value which is outside the allowable range (screen 1120), the slide bar turns red and a “Reason” field appears below the slider (magnified view at screens 1130, 1140), where the user can explain the reason why the value of the field is outside the allowable range.

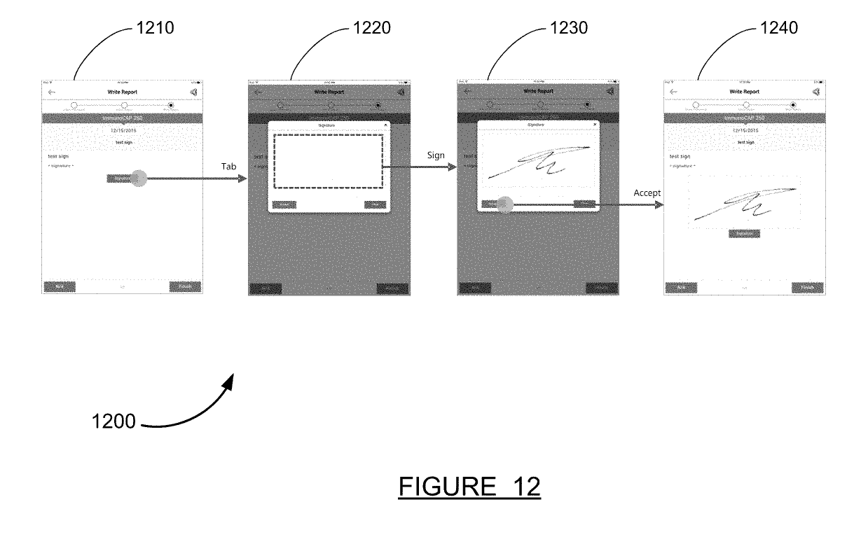

Some reports require a user signature for regulatory reasons. FIG. 12 is an illustration 1200 of a sequence of mobile tablet application pages for a technician user completing a signature question in LACS, in accordance with an embodiment of the disclosed system. When a report needs to be signed, the technician user will be presented with a signature button as shown on screen 1210. The technician taps on the signature button and is presented with a signature box as shown on screen 1220. The technician signs in the signature box using a finger tip and taps on an accept button, as shown on screen 1230. The captured signature is shown on screen 1240. The technician can then finish the report as normal.

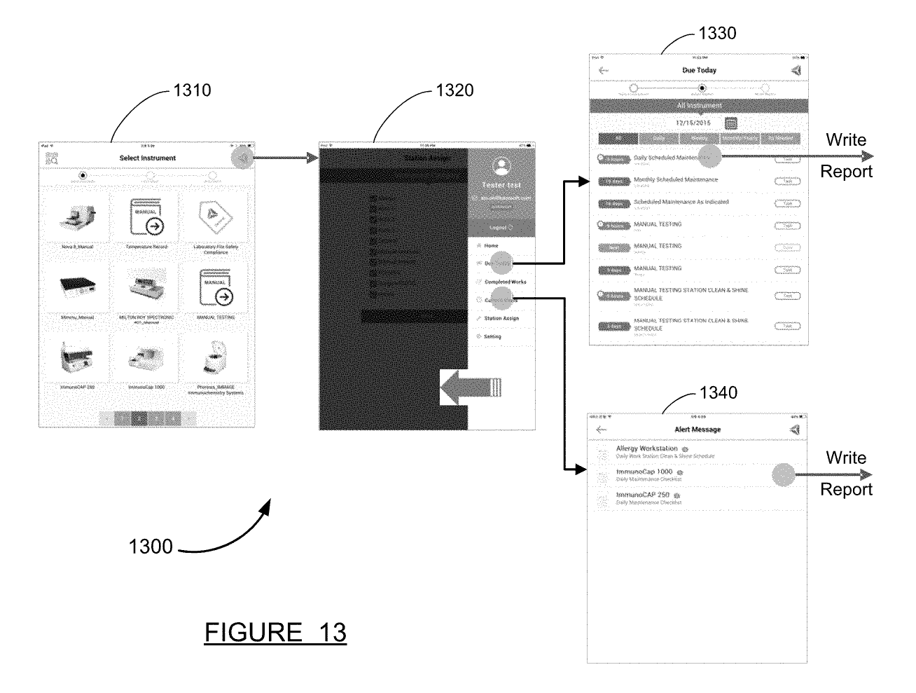

FIGS. 6-9, discussed above, showed one way for a technician user to select station assignments, view instruments, and select a report to complete. Another interface option is available in the LACS system for finding and selecting reports to complete. FIG. 13 is an illustration 1300 of a sequence of mobile tablet application pages for navigating using a side navigation menu, in accordance with an embodiment of the disclosed system. From almost any screen in the mobile tablet application 140, the user can tap an icon at the top right to display a right side navigation menu, as shown in screens 1310 and 1320. The right side navigation menu includes the following selection options; Home, Due Today, Completed Works, Current Alerts, Station Assign and Settings.

The Home selection on the right side navigation menu simply takes the user to the Home page, where the user would have landed after logging into the tablet application 140. The Due Today selection on the right side navigation menu takes the user to a screen 1330 of reports which are due on the current day, for the user's assigned stations. The Due Today screen 1330 is a convenient way for a user to see all reports due on the current day, where the due reports may be associated with multiple stations and multiple instruments. From the Due Today screen 1330, the user can tap on one of the displayed reports to open a screen (as shown in FIG. 10) to write the report.

Tapping the Completed Works option on the right side navigation menu takes the user to a screen of reports which have been completed by the user, where the Completed Works screen includes an icon indicating whether a report was completed normally, completed with a status of N/A, or was a non-scheduled report which was completed. From the Completed Works screen, the user can tap on any of the completed reports to view it; for example, the user might want to view one of the N/A reports to be reminded of the reason that report was not applicable for the particular date/time.

Tapping the Current Alerts selection on the right side navigation menu takes the user to a screen 1340 which displays all current alerts for the user, based on their station assignments. The Current Alerts screen 1340 provides a quick way for a user to see all overdue reports, where the overdue reports may be associated with multiple stations and multiple instruments. From the Current Alerts screen 1340, the user can tap on one of the displayed overdue reports to open a screen (as shown in FIG. 10) to write the report.

The Station Assign selection on the right side navigation menu takes the user to a list of stations for assignment selection, as shown in FIG. 6. The Settings selection on the right side navigation menu simply takes the user to an account settings page where the user can, for example, change their password. Any time the user wants to eliminate the display of the right side navigation menu on the tablet application 140, the user can swipe to the left to return to the screen they were on previously, as shown at the bottom of the screen 1320.

The preceding discussion of FIGS. 6-13 provides an understanding of how the mobile tablet application 140 is used by technicians to complete maintenance log reports which the technicians would have traditionally filled out on paper. The final type of functionality provided by the LACS system is found in the supervisor application 130 of FIG. 1. The supervisor application 130 is a collection of features which enable laboratory supervisors to understand everything from report compliance percentages to technician productivity—where the supervisors may first view the available data as a high level overview, and then drill down to a very detailed look at an individual report or an individual technician.

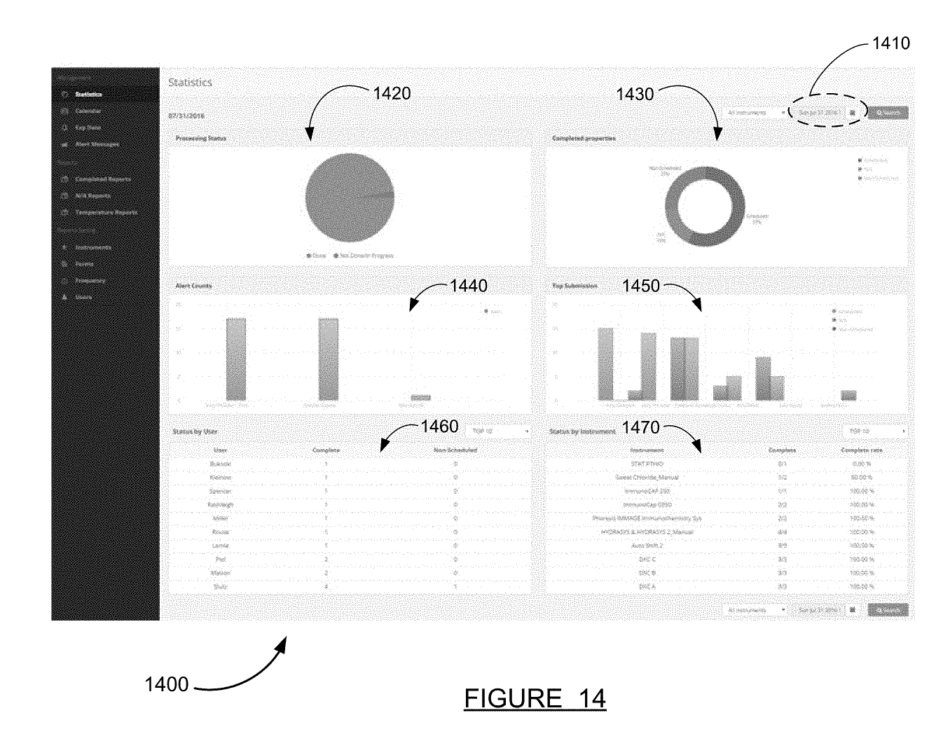

FIG. 14 is an illustration of a dashboard screen 1400 which displays statistics from LACS, in accordance with an embodiment of the disclosed system. The dashboard screen 1400 is the default login screen for a supervisor, and may also be selected by a supervisor by clicking on the Statistics button in the left sidebar. The supervisor starts by selecting a date of interest for the dashboard screen 1400, as shown at 1410. The default date is “yesterday”, as report processing for the current date will normally not yet be completed. Several features for viewing report data for a particular day are available, as shown in FIG. 14.

Processing Status section 1420 provides the ratio of complete to incomplete tasks for the current day as a pie chart. The percentage of completed tasks are shown in blue, while incomplete tasks are shown in red. Any task which is included in the “Not Done” part of the pie could be in progress but just not yet completed and finished.

Completed Properties section 1430 displays a percentage of all completed tasks in three categories as a donut chart. Scheduled tasks, shown in purple, are completed tasks which have a frequency applied, occurring at some regular interval. Nonscheduled tasks, shown in green, do not have a frequency applied and may be one time tasks which have been completed. The third category, shown in blue, is N/A. These may be tasks which were alerted or otherwise completed by a technician, but were not required at that time and were therefore submitted as N/A rather than a fully completed report.

Alert Counts section 1440 displays the number of alerts by technician user. If a technician is getting an abnormally high number of alerts, they may need to be counseled about time management, or their workload may need to be adjusted.

Top Submission section 1450 shows the number of reports completed by each technician within three categories; Scheduled, Non-scheduled and N/A. This graph may be used by a supervisor to help balance the load of work shared between technicians.

Status by User section 1460 shows the number of forms completed during the current day by each technician in tabular form. The “Complete” column includes both completed and N/A forms, while the “Non-Scheduled” column refers to any forms which have been filled-in, but do not have a required frequency.

Status by Instrument section 1470 shows the total number of forms completed for each instrument for the current day, also in tabular form. Columns include complete (# completed/# due) and completion rate as a percentage.

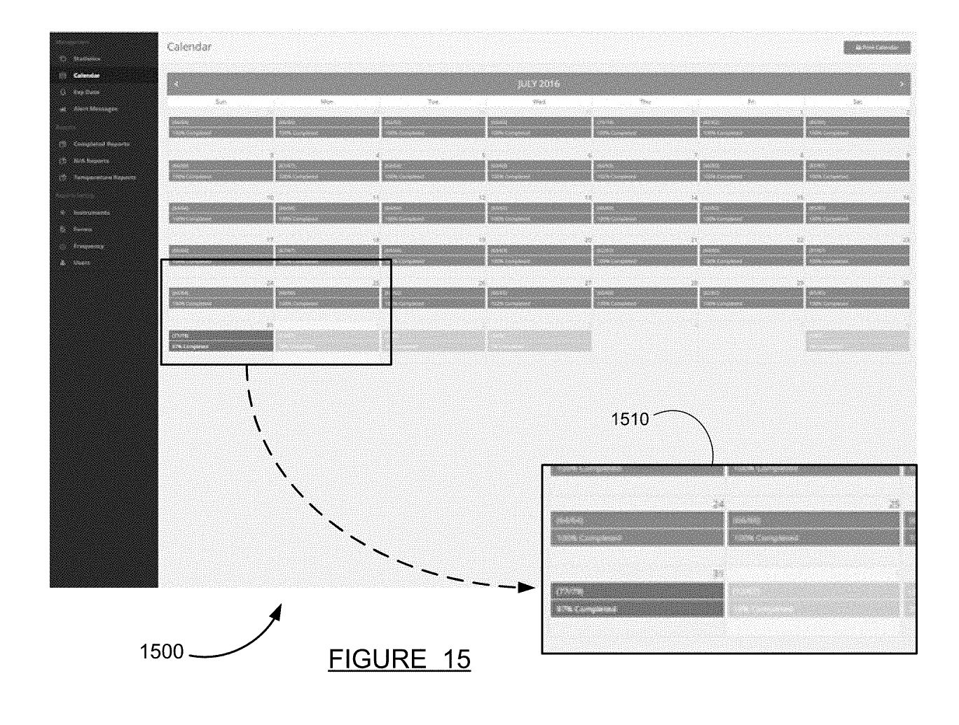

FIG. 15 is an illustration of a calendar screen 1500 which displays LACS statistics in a calendar format, in accordance with an embodiment of the disclosed system. The calendar screen 1500 may be selected by a supervisor by clicking on the Calendar button in the left sidebar. The calendar screen 1500 shows color coded completion rate by day for a calendar month. For example, days having a completion rate of 100% are shown in green, and different colors are used to designate completion rate ranges of 75-99%, 50-75%, 25-50% and 0-25%. Future dates on the calendar are shown in yellow. In zoom section 1510, two dates from the previous week having 100% completion are shown in green, the present date having 97% completion is shown in purple, and “tomorrow” is shown in yellow because it is in the future, even though it already has a small number of reports complete.

Clicking on a date will open a window displaying more details for the given day. This will display not only the users who submitted forms, but also their completion rate. The complete forms count for both the scheduled and N/A forms, whereas non-scheduled forms refer to forms with no frequency.

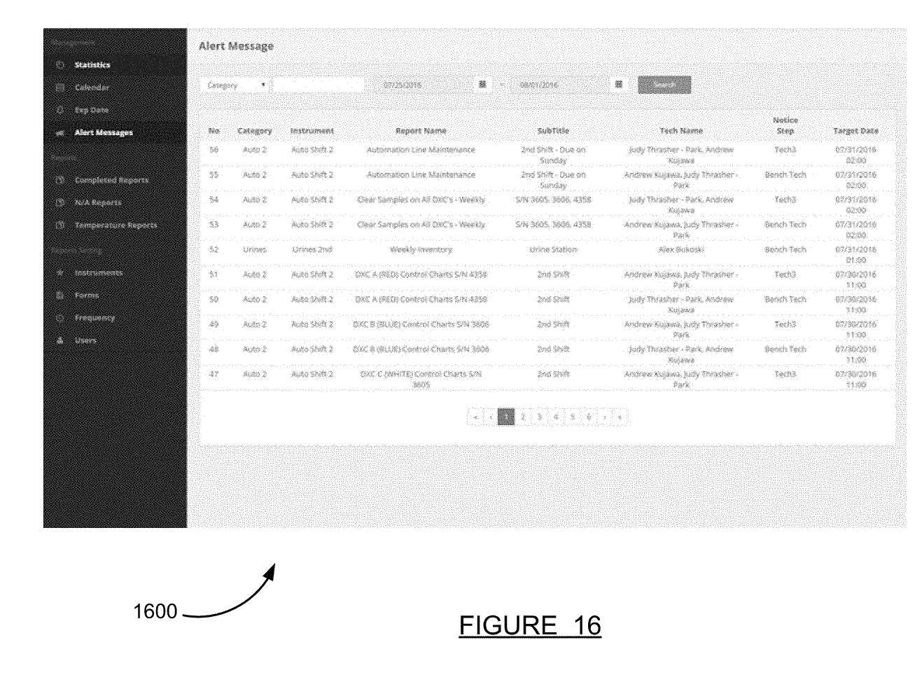

FIG. 16 is an illustration of an Alert Messages screen 1600 which displays a table of recent alert messages in LACS, in accordance with an embodiment of the disclosed system. The Alert Messages screen 1600 may be selected by a supervisor by clicking on the Alert Messages button in the left sidebar. The lab administrator or supervisor may find it useful to know how often technicians require alerts to remind them of their workload. This can also be a sign of how effectively lab compliance is being maintained. The Alert Messages screen 1600 lists alerts which were given within a provided timeframe defined by a two dates. Columns in the Alert Messages screen 1600 include Station, Instrument, Report Name, Technician Name and Target Date/Time that the report should have been completed. These results can be sorted and filtered by station, instrument and report name.

Administrators will receive emails about forms which have not been reviewed and marked as completed. These emails will continue to be sent every day as long as the forms have not been processed in this way. Supervisors can review their alerts to be sure they review and mark as completed all of the overdue finished reports that are awaiting them.

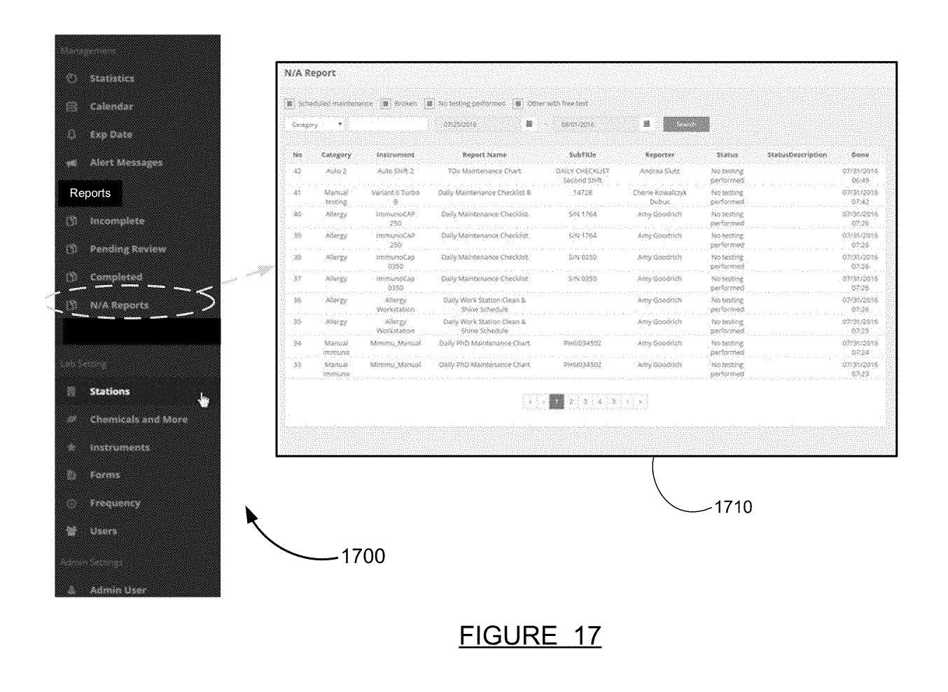

FIG. 17 is an illustration 1700 of a left sidebar menu which contains report reviewing commands in LACS, in accordance with an embodiment of the disclosed system. The supervisor's reviewing and approving of reports is facilitated by the buttons in the Reports section of the left sidebar menu. The left sidebar menu provides access to reports in each of the four different report categories based on their status in the form lifecycle. The four report categories are: Incomplete, Pending Review, Completed and N/A. In the left sidebar, reports are organized into these four states, or stages of process.

Pending Review reports have been finished by the technician but have yet to be reviewed by an administrator or supervisor. A supervisor can see a listing of all reports pending review by clicking on this button. Clicking on an individual pending report, the supervisor can verify that the input is valid, or the data can be corrected by the supervisor, then the supervisor can choose the Mark As Reviewed button to move the report to Completed status. Completed reports have been completed by a technician using the mobile device application 140, and marked as reviewed by a supervisor. A list of all fully completed reports can be viewed by clicking on the Completed button. Incomplete reports are also available for listing using the so-named button, where the incomplete report list shows those reports that are not yet finished by the technician, although they may have been started.

N/A Reports refer to reports which were scheduled, and were addressed by a technician, but were marked N/A by the technician. This can happen when a scheduled report was not applicable (for one of the reasons listed below). An example of the N/A report listing is shown at 1710. The N/A report listing includes a color key which indicates the reason that a report was designated as N/A by the technician—where the reasons include; instrument was out of service for scheduled maintenance, instrument was broken, instrument had no testing performed during the time period, or other (with text input by technician). All of the report listing pages have a date range which is set at the top.

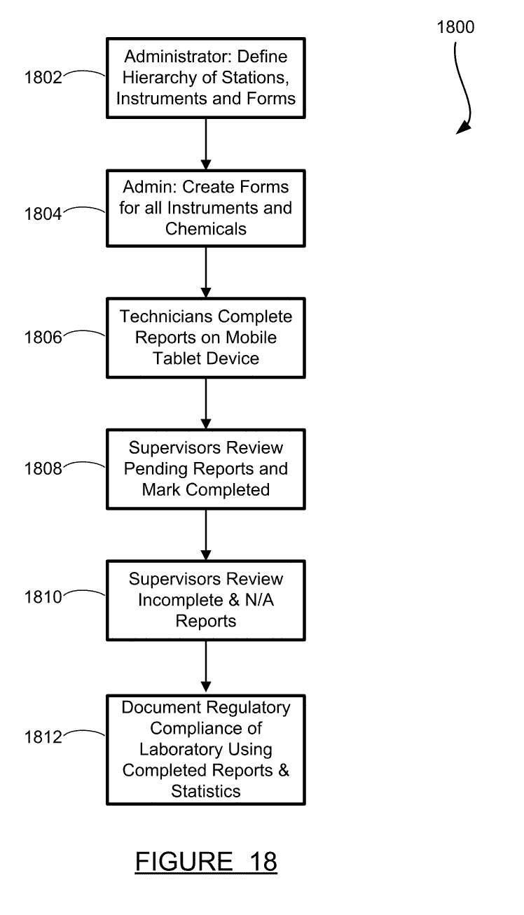

FIG. 18 is a flowchart diagram 1800 of a method for tracking equipment maintenance tasks employing the features of the LACS system shown in FIGS. 1-17. At box 1802, an administrator defines a hierarchy of stations, instruments (and chemicals) and forms for a laboratory using the administrative portal 120—where the laboratory may have multiple stations, each station may have multiple instruments, and each instrument may have multiple maintenance log forms. At box 1804, the administrator creates all of the maintenance log forms for all of the instruments (and chemicals) using form builder tools in LACS—where each form may have multiple slides consisting of questions to be answered by a technician. Forms have specific due date frequencies (or are designated as non-scheduled), and alert notification and email policies are defined for each form.

At box 1806, technicians fill out reports which are due for instruments in the stations to which the technicians are assigned. These technician activities are completed on the tablet device 142 running the mobile table application 140. Technicians have many LACS features at their disposal for selecting and completing reports, as discussed above and shown in FIGS. 6-13. For example, technicians can respond to an alert to jump to an overdue report, or they can follow a hierarchy of stations and instruments to view the associated report list, or they can use menu tools such as Due Today to find reports that are due on the current work shift. Furthermore, technicians can save drafts of partially-completed reports, complete a report for a non-scheduled activity, and designate a scheduled report as “N/A” if the instrument was not available or not used for testing.

At box 1808, supervisors review pending reports, make any necessary corrections and verify form contents, and mark the forms as completed. Along with reviewing pending reports and marking them completed, supervisors can use the LACS system to evaluate laboratory productivity in many other ways. For example, Top Submissions and Status by User charts can be used to determine which technicians are completing the most work, which may be overloaded with work, and which are missing the most work assignments and causing alerts. Using these tools, workload balance and productivity can be improved.

At box 1810, supervisors review reports marked as incomplete or N/A and take appropriate action. One such action is to view the status and owner of incomplete reports and follow up to ensure that they are completed in a timely fashion. In addition, other insights into laboratory operations are possible—such as understanding the underlying causes of N/A reports, whether due to broken equipment, lack of testing activity, or otherwise.

At box 1812, supervisors and other management personnel document regulatory compliance of the laboratory's maintenance, cleaning and calibration activities, using the completed reports and statistics from the LACS system. With all reports and statistics available in the LACS database, management may preview laboratory performance to ensure that there are no issues related to regulatory compliance, and the LACS system can be used to readily produce any documents and answer any questions for the compliance auditor at the time of the audit.

It is to be understood that the software applications and modules described above are executed on one or more computing devices having a processor and a memory module. For example, the LACS database and associated software executes on the server computer 110, while the administrative portal 120 and the supervisor application 130 execute (either natively or via a browser application) on desktop computers 122/132 in communication with the server 110. Likewise, the mobile tablet application 140 runs on a tablet device, such as an iPad, configured with the mobile application 140 and in communication with the server 110. Furthermore, the communication between the mobile devices and the application server may use any suitable wireless technology—such as a cellular phone/data network, Wi-Fi, broadband Internet, etc.

The methods and systems disclosed above have been demonstrated as a dramatic improvement over the old paper-based laboratory equipment maintenance tracking. Using the LACS system, paper is eliminated, proper completion of all questions on a report form is ensured, late reports are automatically flagged with alert notifications until completed, and all completed reports and statistics are readily available for documenting regulatory compliance of the laboratory's maintenance activity.

While a number of exemplary aspects and embodiments of the system for tracking and maintaining medical laboratory equipment have been discussed above, those of skill in the art will recognize modifications, permutations, additions and sub-combinations thereof. For example, it is understood that any asset or equipment requiring regularly-scheduled maintenance, calibration and/or cleaning may be managed in accordance with the invention. It is therefore intended that the following appended claims and claims hereafter introduced are interpreted to include all such modifications, permutations, additions and sub-combinations as are within their true spirit and scope.

What is claimed is:

1. A computer program containing instructions for causing one or more computers to perform an equipment maintenance tracking method including steps of:
defining a hierarchy of stations, instruments and report forms for a laboratory, by a system administrator, where the laboratory includes one or more stations, each station includes one or more instruments, and each instrument has one or more report forms;
creating the report forms for all of the instruments, by the system administrator, where each of the report forms includes one or more slides having questions about an instrument, and each report form is designated as either a non-scheduled activity or a scheduled activity having a designated frequency;
completing the report forms by technicians in the laboratory, where completing the report forms includes answering all of the questions on each of the report forms and submitting the report forms as pending reports;
reviewing the pending reports, making any necessary corrections, and marking the pending reports as completed reports, by a supervisor; and
documenting regulatory compliance of the laboratory using the completed reports and statistics about the completed reports.

2. The computer program according to claim 1 wherein the one or more computers include a server computer hosting a database containing the report forms and associated data, one or more personal computers communicating with the server computer and used to execute the steps of defining the hierarchy, creating the report forms, reviewing the pending reports and documenting regulatory compliance, and a plurality of mobile tablet devices wirelessly communicating with the server computer and used for completing the report forms by the technicians.

3. The computer program according to claim 2 wherein the mobile table devices wirelessly communicate with the server computer using cellular communications, Wi-Fi, or both.

4. The computer program according to claim 1 further comprising defining an alert notification policy for each of the forms for a scheduled activity, where the alert notification policy determines a time at which to send an alert when the scheduled activity is not completed on time, and the policy also determines to whom the alert is sent, and whether the alert is sent via a system notification or email.

5. The computer program according to claim 1 wherein completing the report forms includes receiving an alert notification of an overdue report form not completed by a due date/time based on the designated frequency, and completing the overdue report form.

6. The computer program according to claim 1 wherein completing the report forms includes defining one or more assigned stations for the technician and viewing a list of report forms with due date/time for all of the instruments in the assigned stations, said list being filterable by all reports or reports with daily, weekly, monthly or yearly frequencies.

7. The computer program according to claim 6 wherein completing the report forms further includes viewing a list of report forms due on a current day.

8. The computer program according to claim 6 wherein completing the report forms further includes completing one or more of the report forms for non-scheduled activities.

9. The computer program according to claim 1 wherein completing the report forms by technicians further includes partially completing a report form and saving the partially completed report form as a draft to be completed later.

10. The computer program according to claim 1 wherein completing the report forms by technicians further includes designating a report form as not applicable (N/A) when the report form applies to an instrument which was out of service or not used during a report time frame.

11. The computer program according to claim 1 wherein each of the questions on the report forms has a question type, and the question types include yes/no selections, drop lists, checkboxes allowing multiple selections, radio buttons allowing a single selection, range slider bars, and text entry fields having specific formatting options of date, text, number and auto-complete.

12. The computer program according to claim 11 wherein the range slider bar questions automatically add a text field allowing the technician to designate a reason when a value outside a normal range is selected with the slider bar.

13. The computer program according to claim 11 wherein the report forms also include a signature field requiring a signature by the technician.

14. The computer program according to claim 1 further comprising viewing a statistics dashboard by the supervisor, where the statistics dashboard applies to a designated time period and includes a graph of complete vs. incomplete status, a graph showing scheduled, non-scheduled and N/A percentages of completed reports, a graph of alert counts per technician, and a graph of report submissions per technician.

15. The computer program according to claim 14 wherein the statistics dashboard also includes a status by user section which shows report forms completed during the designated time period by each technician in tabular form, including a “Completed” column including both completed and N/A report forms, and a “Non-scheduled” column including any report forms which have been filled in but do not have a required frequency.

16. The computer program according to claim 14 wherein the statistics dashboard also includes a status by instrument section which shows the total number of report forms completed for each instrument for the designated time period in tabular form, including a number of report forms completed, a number of report forms due, and completion rate as a percentage.

17. The computer program according to claim 1 further comprising viewing a compliance calendar by the supervisor, where the compliance calendar displays a color-coded completion rate for each day.

18. The computer program according to claim 1 wherein documenting regulatory compliance of the laboratory includes displaying report completion data by date, by station, by instrument, by report form, by technician, and by scheduled, non-scheduled and N/A report type.

19. A system for tracking equipment maintenance, said system comprising:
a server computer including a processor, a memory module and a network connection, where the server computer is configured with a database defining a hierarchy of stations, instruments and report forms for a laboratory, where the laboratory includes one or more stations, each station includes one or more instruments, and each instrument has one or more report forms, and where each of the report forms includes one or more slides having questions about an instrument, and each report form is designated as either a non-scheduled activity or a scheduled activity having a designated frequency;
a plurality of mobile tablet devices including a processor and a memory module and wirelessly communicating with the server computer, where the mobile tablet devices are configured for completing the report forms by technicians, where completing the report forms includes answering all of the questions on each of the report forms and submitting the report forms as pending reports; and
one or more personal computers including a processor and a memory module and communicating with the server computer, where the personal computers are configured for reviewing the pending reports, making any necessary corrections, and marking the pending reports as completed reports, and for documenting regulatory compliance of the laboratory using the completed reports and statistics about the completed reports residing in the server computer.

20. A method for tracking equipment maintenance, said method comprising:
defining a hierarchy of stations, instruments and report forms for a laboratory, by a system administrator using a personal computer communicating with a server computer, where the laboratory includes one or more stations, each station includes one or more instruments, and each instrument has one or more report forms;
creating the report forms for all of the instruments, by the system administrator using the personal computer, where each of the report forms includes one or more slides having questions about an instrument, and each report form is designated as either a non-scheduled activity or a scheduled activity having a designated frequency;
completing the report forms by technicians using a plurality of mobile tablet devices wirelessly communicating with the server computer, where completing the report forms includes answering all of the questions on each of the report forms and submitting the report forms as pending reports;
reviewing the pending reports, making any necessary corrections, and marking the pending reports as completed reports, by a supervisor using the personal computer; and
documenting regulatory compliance of the laboratory using the completed reports and statistics about the completed reports residing in the server computer.
